(19) United States
(12) Patent Application Publication
(10) Pub. No.: US 2012/0236745 A1
(43) Pub. Date: Sep. 20, 2012

(54) TERMINAL APPARATUS FOR TRANSMITTING OR RECEIVING A SIGNAL INCLUDING PREDETERMINED INFORMATION

(75) Inventors: Makoto NAGAI, Kakamigahara City (JP); Keisuke Higuchi, Ichinomiya City (JP)

(73) Assignee: SANYO ELECTRIC CO., LTD, Osaka (JP)

(21) Appl. No.: 13/425,077

(22) Filed: Mar. 20, 2012

Related U.S. Application Data
(63) Continuation of application No. PCT/JP2010/071093, filed on Nov. 26, 2010.

(30) Foreign Application Priority Data
Nov. 27, 2009 (JP) 2009-270699
Nov. 27, 2009 (JP) 2009-270700
Nov. 25, 2010 (JP) 2010-262901

(51) Int. Cl. H04W 24/00; H04L 12/26

(52) U.S. Cl. 370/252

(57) ABSTRACT

A measuring unit measures a quality of a received packet signal. An estimating unit estimates entry from a second area to a first area when the measured quality is improved so as to satisfy a first condition and estimates the entry from the first area to the second area when the quality measured by the measuring unit is deteriorated so as to satisfy a second condition. The estimating unit sets different values for a parameter included in the first condition and the parameter included in the second condition. The determining unit determines a first period or a second period as transmission timing based on an estimated result.

### BACKGROUND OF THE INVENTION

1. Field of the Invention

The present invention relates to communication technology and especially relates to a terminal apparatus, which transmits or receives a signal including predetermined information.

2. Description of the Related Art

In order to prevent collision accident at an intersection, road-to-vehicle communication has been studied. In the road-to-vehicle communication, information about a status of the intersection is communicated between a roadside apparatus and an in-vehicle apparatus. In the road-to-vehicle communication, it is required to install the roadside apparatus, so that time and effort and cost increase.

On the other hand, in inter-vehicle communication, that is to say, a mode to communicate the information between the in-vehicle apparatuses, it is not required to install the roadside apparatus. In this case, it is determined on which road, which enters the intersection, its own vehicle and another vehicle are located by detecting current positional information in real time by a global positioning system (GPS) and the like and exchanging the positional information between the in-vehicle apparatuses, for example.

In a wireless local area network (LAN) supporting the IEEE802.11 standards and the like, an access control function referred to as carrier sense multiple access with collision avoidance (CSMA/CA) is used. Therefore, a wireless channel is shared by a plurality of terminal apparatuses in this wireless LAN. In such CSMA/CA, by an effect of a distance between the terminal apparatuses and an obstacle, which attenuates an electric wave, a status in which wireless signals do not reach each other, that is to say, a status in which carrier sense does not act occurs. When the carrier sense does not act, packet signals transmitted from a plurality of terminal apparatuses collide with each other.

On the other hand, when the wireless LAN is applied to the inter-vehicle communication, since it is required that the information is transmitted to an undefined number of terminal apparatuses, it is preferable that the signal is broadcast-transmitted. However, at the intersection and the like, by increase in traffic by increase in the number of vehicles, that is to say, increase in the number of terminal apparatuses, it is supposed that collision of the packet signals increases. As a result, data included in the packet signal is not transferred to another terminal apparatus. When such a state occurs in the inter-vehicle communication, an object to prevent the collision accident at the intersection is not achieved. Further, when the road-to-vehicle communication is executed in addition to the inter-vehicle communication, there are various communication modes. At that time, it is required to decrease a mutual effect between the inter-vehicle communication and the road-to-vehicle communication.

Also in a case in which there are the various communication modes, it may be said that the packet signal transmitted from the terminal apparatus mounted on the vehicle in the vicinity of the intersection is more important than the packet signal transmitted from the terminal apparatus mounted on the vehicle away from the intersection in terms of decreasing the collision accident. Therefore, also when the number of terminal apparatuses increases, it is desired that the collision probability of the former packet signal is lower than the collision probability of the latter packet signal. In order to realize this, a period for transmitting the former packet signal and a period for transmitting the latter packet signal are time-division multiplexed, and timing is more strictly controlled in the former period than in the latter period, for example. At that time, it is desired for the terminal apparatus to correctly specify in which period the signal should be transmitted. This is to correctly specify whether this is present in the vicinity of a base station apparatus or away from the same.

### SUMMARY OF THE INVENTION

The present invention is achieved in consideration of such a status, and an object thereof is to provide technology to specify in which area the terminal apparatus is present.

In order to solve the above-described problem, a terminal apparatus according to an aspect of the present invention is a terminal apparatus, which might be moved, wherein a subframe in which a first period, which should be used by the terminal apparatus present in a first area formed around a base station apparatus for transmitting a packet signal, and a second period, which should be used by the terminal apparatus present in a second area formed on the outside of the first area for transmitting the packet signal, are time-division multiplexed is defined and a frame in which a plurality of subframes are time-division multiplexed is defined, including: a receiving unit configured to receive the packet signal from the base station apparatus; a measuring unit configured to measure a quality of the packet signal received by the receiving unit; an estimating unit configured to estimate entry from the second area to the first area when the quality measured by the measuring unit is improved so as to satisfy a first condition and to estimate the entry from the first area to the second area when the quality measured by the measuring unit is deteriorated so as to satisfy a second condition; a determining unit configured to determine the first period or the second period as transmission timing based on an estimated result by the estimating unit; and a transmitting unit configured to transmit the packet signal at the transmission timing determined by the determining unit. The estimating unit sets different values for a parameter included in the first condition and the parameter included in the second condition.

Another aspect of the present invention also is the terminal apparatus. The apparatus is a terminal apparatus, which might be moved, wherein a subframe including a period, which should be used by the terminal apparatus present in an area formed around a base station apparatus for transmitting a packet signal is defined and a frame in which a plurality of subframes are time-division multiplexed is defined, including: a receiving unit configured to receive the packet signal from the base station apparatus; a measuring unit configured to measure a quality of the packet signal received by the receiving unit; an estimating unit configured to estimate entry from the outside of the area to the area when the quality measured by the measuring unit is improved so as to satisfy a first condition and to estimate the entry from the area to the outside of the area when the quality measured by the measuring unit is deteriorated so as to satisfy a second condition; a determining unit configured to determine the period or timing unrelated to a configuration of the frame as transmission timing based on an estimated result by the estimating unit; and a transmitting unit configured to transmit the packet signal at the transmission timing determined by the determining unit. The estimating unit sets different values for a parameter included in the first condition and the parameter included in the second condition.

Still another aspect of the present invention also is the terminal apparatus. The apparatus is a terminal apparatus, which might be moved, wherein a subframe in which a first period, which should be used by the terminal apparatus present in a first area formed around a base station apparatus for transmitting a packet signal, and a second period, which should be used by the terminal apparatus present in a second area formed on the outside of the first area for transmitting the packet signal, are time-division multiplexed is defined and a frame in which a plurality of subframes are time-division multiplexed is defined, including: a receiving unit configured to receive the packet signal from the base station apparatus; a first measuring unit configured to measure power of the packet signal received by the receiving unit; a first estimating unit configured to estimate whether the terminal apparatus is present in the first area or in the second area based on the power measured by the first measuring unit; a second measuring unit configured to measure an error rate of the packet signal received by the receiving unit; a second estimating unit configured to estimate whether the terminal apparatus is present in the second area or on the outside of the second area based on the error rate measured by the second measuring unit; a determining unit configured to determine any one of the first period, the second period, and timing unrelated to a configuration of the frame as transmission timing based on at least one of an estimated result by the second estimating unit and the estimated result by the first estimating unit; and a transmitting unit configured to transmit the packet signal at the transmission timing determined by the determining unit. The first estimating unit stops estimating when the terminal apparatus is present on the outside of the second area, and the second estimating unit stops estimating when the terminal apparatus is present in the first area.

Meanwhile, optional combination of the above-described components and those obtained by converting representation of the present invention among a method, an apparatus, a system, a recording medium, and a computer program also are effective as an aspect of the present invention.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is a view illustrating a configuration of a communication system according to an embodiment of the present invention;

FIG. 2 is a view illustrating a configuration of a base station apparatus in FIG. 1;

FIGS. 3A to 3E are views illustrating a format of a frame defined by the communication system in FIG. 1;

FIG. 4 is a view illustrating a configuration of a subframe in FIG. 3;

FIGS. 5A and 5B are views illustrating a format of a MAC frame stored in a packet signal defined by the communication system in FIG. 1;

FIG. 6 is a view illustrating a configuration of a terminal apparatus mounted on a vehicle in FIG. 1;

FIG. 7 is a view illustrating a data structure of a table stored in an estimating unit in FIG. 6;

FIG. 8 is a view illustrating a data structure of another table stored in the estimating unit in FIG. 6;

FIGS. 9A to 9C are views illustrating the data structure of the table stored in the storage unit in FIG. 6;

FIG. 10 is a view illustrating an outline of an estimation process by the estimating unit in FIG. 6;

FIG. 11 is a flowchart illustrating an estimation procedure of an area by the terminal apparatus in FIG. 6;

FIG. 12 is a view illustrating the configuration of the subframe according to a modified example of the present invention;

FIG. 13 is a flowchart illustrating the estimation procedure of the area according to the modified example of the present invention; and

FIG. 14 is a flowchart illustrating another estimation procedure of the area according to the modified example of the present invention.

### DETAILED DESCRIPTION OF THE INVENTION

The invention will now be described by reference to the preferred embodiments. This does not intend to limit the scope of the present invention, but to exemplify the invention.

Before specifically describing the present invention, we describe an outline thereof. An embodiment of the present invention relates to a communication system, which executes inter-vehicle communication between terminal apparatuses mounted on vehicles and also executes road-to-vehicle communication from a base station apparatus installed at an intersection and the like to the terminal apparatus. As the inter-vehicle communication, the terminal apparatus broadcast-transmits a packet signal in which information such as a speed and a position of the vehicle (hereinafter, referred to as “data”) is stored. Also, another terminal apparatus receives the packet signal and recognizes an approach of the vehicle and the like based on the data. Also, as the road-to-vehicle communication, the base station apparatus repeatedly defines a frame including a plurality of subframes. The base station apparatus selects any of a plurality of subframes and broadcast-transmits the packet signal in which control information and the like is stored during a period on a head part of the selected subframe.

The control information includes information about a period for this base station apparatus to broadcast-transmit the packet signal (hereinafter, referred to as “road-to-vehicle transmission period”). The terminal apparatus specifies the road-to-vehicle transmission period based on the control information and transmits the packet signal during a period other than the road-to-vehicle transmission period. In this manner, the road-to-vehicle communication and the inter-vehicle communication are time-division multiplexed, so that collision probability of the packet signals of both of them is decreased. That is to say, by recognition of contents of the control information by the terminal apparatus, interference between the road-to-vehicle communication and the inter-vehicle communication is decreased. Also, areas in which the terminal apparatuses, which execute the inter-vehicle communication, are present are principally classified into three types.

One is the area formed around the base station apparatus (hereinafter, referred to as a “first area”), another one is the area formed on the outside of the first area (hereinafter, referred to as a “second area”), and still another one is the area formed on the outside of the second area (hereinafter, referred to as the “outside of the second area”). Herein, although the terminal apparatus may receive the packet signal from the base station apparatus with a certain level of quality in the first area and the second area, the terminal apparatus cannot receive the packet signal from the base station apparatus with a certain level of quality on the outside of the second area. Also, the first area is formed so as to be closer to the center of the intersection than the second area. The vehicle present in the first area is the vehicle present in the vicinity of the intersection, so that it may be said that the packet signal from the terminal apparatus mounted on this vehicle is important information in terms of inhibition of collision accident.

In order to respond to this, a period for the inter-vehicle communication (hereinafter, referred to as “inter-vehicle transmission period”) is formed by time-division multiplex of a priority period and a general period. The priority period is the period used by the terminal apparatus present in the first area and the terminal apparatus transmits the packet signal in any of a plurality of slots, which form the priority period. Also, the general period is the period used by the terminal apparatus present in the second area and the terminal apparatus transmits the packet signal using a CSMA method in the general period. Meanwhile, the terminal apparatus, which is present on the outside of the second area, transmits the packet signal using the CSMA method irrespective of a configuration of the frame. Therefore, it is important for the terminal apparatus mounted on the vehicle to determine in which area this is present. The terminal apparatus according to this embodiment executes a following process.

The terminal apparatus measures an error rate and received power of the packet signal from the base station apparatus. The terminal apparatus estimates whether this is present in the second area or this is present on the outside of the second area based on the error rate. Also, the terminal apparatus estimates whether this is present in the first area or this is present in the second area based on the received power. Herein, in order to reduce throughput, the terminal apparatus stops an estimation process by the received power when this is estimated to be present on the outside of the second area, and stops the estimation process by the error rate when this is estimated to be present in the first area. On the other hand, when this is present in the vicinity of a boundary of the areas, an estimated result of the area might be changed frequently. Such operation might cause deterioration in stability of the communication system.

Therefore, hysteresis is provided in a case of transition from the outside of the second area to the second area and in a case of transition from the second area to the outside of the second area. For example, in the former case, a condition is such that the error rate is not higher than a threshold in three consecutive frames and in the latter case, the condition is such that the error rate is higher than the threshold in five consecutive frames. That is to say, in order to realize the hysteresis, different numbers of times are set. Such a process is similar also for the transition between the first area and the second area.

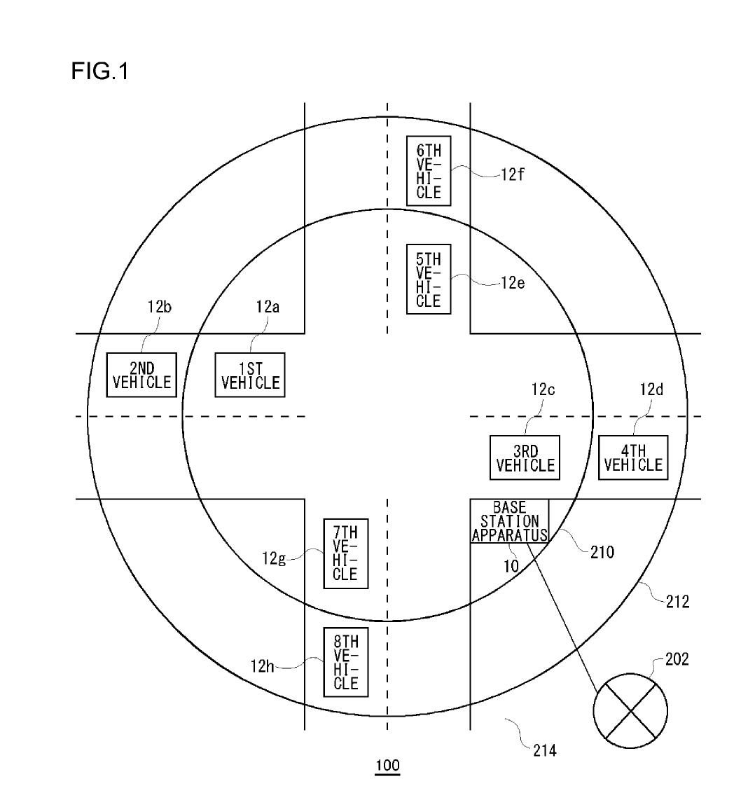

FIG. 1 illustrates a configuration of a communication system 100 according to the embodiment of the present invention. This corresponds to a case in which one intersection is seen from above. The communication system 100 includes a base station apparatus 10, a first vehicle 12a, a second vehicle 12b, a third vehicle 12c, a fourth vehicle 12d, a fifth vehicle 12e, a sixth vehicle 12f, a seventh vehicle 12g, and an eighth vehicle 12h collectively referred to as vehicles 12, and a network 202. Meanwhile, the terminal apparatus not illustrated is mounted on each vehicle 12. Also, a first area 210 is formed around the base station apparatus 10, a second area 212 is formed on the outside of the first area 210, and the outside of the second area 214 is formed on the outside of the second area 212.

As illustrated, a road in a horizontal direction, that is to say, in a right-left direction of the drawing and a road in a vertical direction, that is to say, in an up-down direction of the drawing intersect with each other on a central portion. Herein, an upper side of the drawing corresponds to the “north”, a left side thereof corresponds to the “west”, a lower side thereof corresponds to the “south”, and a right side thereof corresponds to the “east”. Also, a portion at which the two roads intersect with each other is the “intersection”. The first vehicle 12a and the second vehicle 12b travel from left to right, and the third vehicle 12c and the fourth vehicle 12d travel from right to left. Also, the fifth vehicle 12e and the sixth vehicle 12f travel from above downward, and the seventh vehicle 12g and the eighth vehicle 12h travel from below upward.

The communication system 100 arranges the base station apparatus 10 at the intersection. The base station apparatus 10 repeatedly generates the frame including a plurality of subframes based on a signal received from a GPS satellite not illustrated and the frame formed by another base station apparatus 10 not illustrated. Herein, it is defined such that the road-to-vehicle transmission period may be set on the head part of each subframe. The base station apparatus 10 selects the subframe in which the road-to-vehicle transmission period is not set by another base station apparatus 10 in a plurality of subframes. The base station apparatus 10 sets the road-to-vehicle transmission period on the head part of the selected subframe. The base station apparatus 10 stores the control information including the information about the road-to-vehicle transmission period and the like in the packet signal. The base station apparatus 10 also stores predetermined data in the packet signal. The base station apparatus 10 broadcasts the packet signal during the set road-to-vehicle transmission period.

Herein, the first area 210 and the second area 212 are formed around the communication system 100 according to a reception status when the terminal apparatus receives the packet signal from the base station apparatus 10. As illustrated, the first area 210 is formed as an area in which the reception status is relatively excellent in the vicinity of the base station apparatus 10. It also may be said that the first area 210 is formed in the vicinity of the central portion of the intersection. On the other hand, the second area 212 is formed as an area in which the reception status is deteriorated than that in the first area 210 on the outside of the first area 210. Further, the outside of the second area 214 is formed as an area in which the reception status is further deteriorated than that in the second area 212 on the outside of the second area 212. Meanwhile, the error rate and the received power of the packet signal are used as the reception status.

A plurality of terminal apparatuses receive the packet signal broadcasted by the base station apparatus 10 and estimate in which of the first area 210, the second area 212, and the outside of the second area 214 they are present based on the reception status of the received packet signal. When it is estimated that the terminal apparatus is present in the first area 210 or the second area 212, this generates the frame based on the control information included in the received packet signal. As a result, the frame generated by each of a plurality of terminal apparatuses is synchronized with the frame generated by the base station apparatus 10. Also, the terminal apparatus recognizes the road-to-vehicle transmission period set by each base station apparatus 10 and specifies the inter-vehicle transmission period for transmitting the packet signal. Specifically, when the terminal apparatus is present in the first area 210, the priority period is specified and when this is present in the second area 212, the general period is specified. Further, the terminal apparatus executes TDMA in the priority period and executes CSMA/CA in the general period, thereby transmitting the packet signal.

Meanwhile, the terminal apparatus selects the subframe of which relative timing is the same also in a next frame. Especially, in the priority period, the terminal apparatus selects the slot of which relative timing is the same in a next frame. Herein, the terminal apparatus acquires the data and stores the data in the packet signal. The data includes information about a position of presence, for example. The terminal apparatus also stores the control information in the packet signal. That is to say, the control information transmitted from the base station apparatus 10 is transferred by the terminal apparatus. On the other hand, when it is estimated that the terminal apparatus is present on the outside of the second area 214, this transmits the packet signal by executing the CSMA/CA irrespective of the configuration of the frame.

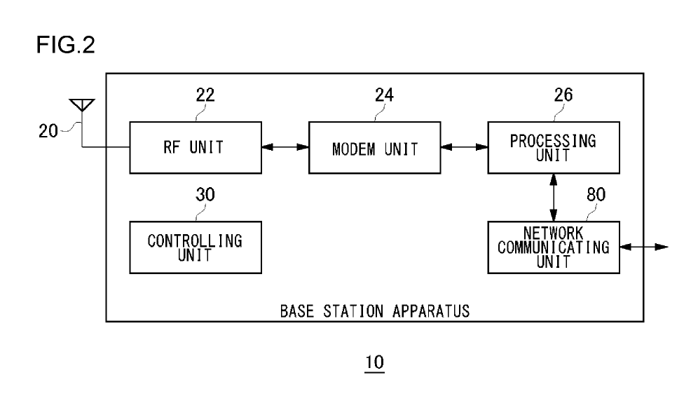

FIG. 2 illustrates a configuration of the base station apparatus 10. The base station apparatus 10 includes an antenna 20, an RF unit 22, a modem unit 24, a processing unit 26, a control unit 30, and a network communicating unit 80.

The RF unit 22 receives the packet signal from the terminal apparatus and another base station apparatus 10 not illustrated by means of the antenna 20 as a reception process. The RF unit 22 executes frequency conversion of the received packet signal at a radio frequency to generate a baseband packet signal. Further, the RF unit 22 outputs the baseband packet signal to the modem unit 24. In general, the baseband packet signal is formed of an in-phase component and a quadrature component, so that two signal lines should be indicated; however, only one signal line is herein indicated in order to make the drawing clear. The RF unit 22 also includes a low noise amplifier (LNA), a mixer, an AGC, and an A/D converting unit.

The RF unit 22 executes the frequency conversion of the baseband packet signal input from the modem unit 24 to generate the packet signal at the radio frequency as a transmission process. Further, the RF unit 22 transmits the packet signal at the radio frequency from the antenna 20 in the road-to-vehicle transmission period. The RF unit 22 also includes a power amplifier (PA), the mixer, and a D/A converting unit.

The modem unit 24 executes demodulation of the baseband packet signal from the RF unit 22 as the reception process. Further, the modem unit 24 outputs a demodulated result to the processing unit 26. Also, the modem unit 24 executes modulation of the data from the processing unit 26 as the transmission process. Further, the modem unit 24 outputs a modulated result to the RF unit 22 as the baseband packet signal. Herein, the communication system 100 supports an orthogonal frequency division multiplexing (OFDM) modulation method, so that the modem unit 24 also executes fast Fourier transform (FFT) as the reception process and executes inverse fast Fourier transform (IFFT) as the transmission process.

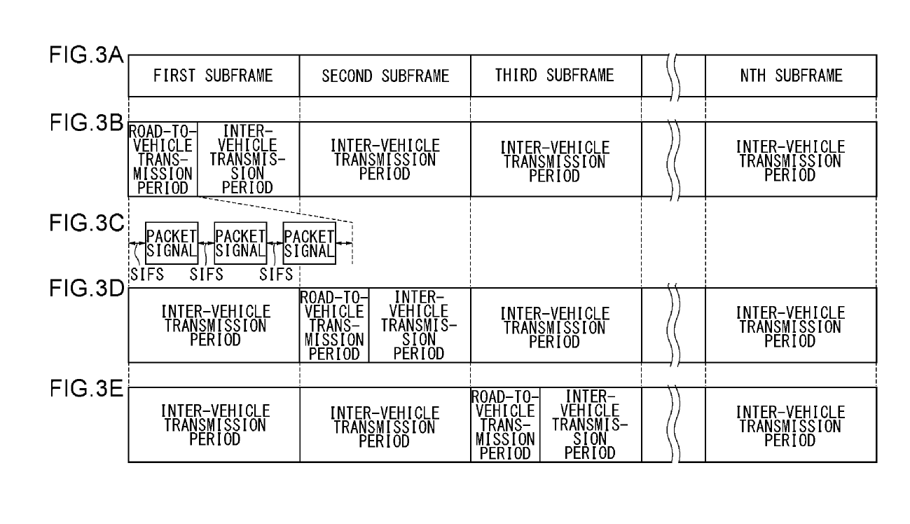

The processing unit 26 accepts the demodulated result from another base station apparatus 10 not illustrated through the RF unit 22 and the modem unit 24. The processing unit 26 repeatedly generates the frame formed of a plurality of subframes based on the demodulated result. FIGS. 3A to 3E illustrate a format of the frame defined by the communication system 100. FIG. 3A illustrates a configuration of the frame. The frame is formed of N subframes, which are represented as first to Nth subframes. For example, when a length of the frame is 100 msec and N is 10, the subframes of which length is 10 msec are defined.

FIG. 3B illustrates a configuration of the frame generated by a first base station apparatus 10a. The first base station apparatus 10a sets the road-to-vehicle transmission period on the head part of the first subframe. Also, the first base station apparatus 10a sets the inter-vehicle transmission period in each of the second to Nth subframes. The inter-vehicle transmission period is the period during which the terminal apparatus may transmit the packet signal. That is to say, it is defined such that the first base station apparatus 10a is capable of transmitting the packet signal during the road-to-vehicle transmission period, which is the head period of a predetermined subframe, and that the terminal apparatus is capable of transmitting the packet signal during the inter-vehicle transmission period other than the road-to-vehicle transmission period of the frame.

FIG. 3C illustrates the packet signal transmitted from the first base station apparatus 10a during the road-to-vehicle transmission period. A plurality of packet signals are continuously transmitted with an interval of SIFS. Herein, since the communication system 100 adopts the OFDM modulation scheme, each packet signal is composed of a plurality of OFDM symbols. Also, the OFDM symbol is composed of a guard interval (GI) and an effective symbol.

FIG. 3D illustrates a configuration of the frame generated by a second base station apparatus 10b. The second base station apparatus 10b sets the road-to-vehicle transmission period on the head part of the second subframe. Also, the second base station apparatus 10b sets the inter-vehicle transmission period in the first subframe and the third to Nth subframes. FIG. 3E illustrates a configuration of the frame generated by a third base station apparatus 10c. The third base station apparatus 10c sets the road-to-vehicle transmission period on the head part of the third subframe. Also, the third base station apparatus 10c sets the inter-vehicle transmission period in the first subframe, the second frame, and the fourth to Nth subframes. In this manner, a plurality of base station apparatuses 10 select the different subframes and set the road-to-vehicle transmission period on the head part of the selected subframe.

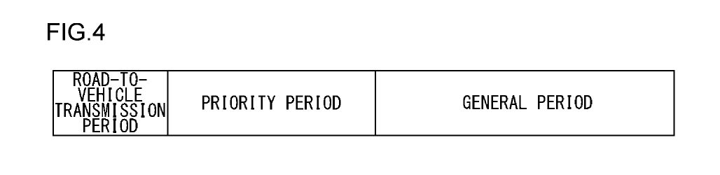

FIG. 4 illustrates a configuration of the subframe. As illustrated, one subframe is composed of the road-to-vehicle transmission period, the priority period, and the general period in this order. The priority period and the general period correspond to the inter-vehicle transmission period in FIG. 3B and the like. Meanwhile, when the road-to-vehicle transmission period is not included in the subframe, the subframe is composed of the priority period and the general period in this order. In the priority period, a plurality of time slots are time-division multiplexed. FIG. 2 is referred to again.

The processing unit 26 detects the control information from the demodulated result. The processing unit 26 specifies reception timing of the control information. The reception timing of the control information is the reception timing of the packet signal including the control information, so that this corresponds to head timing of the subframe in which the road-to-vehicle transmission period is arranged. Also, the processing unit 26 acquires a subframe number included in the control information. Further, this generates the frame based on the head timing of the subframe and the subframe number. Meanwhile, when the processing unit 26 receives the packet signals from a plurality of base station apparatuses 10, this selects the packet signal having the maximum received power and executes the above-described process to the selected packet signal. In this manner, the processing unit 26 generates the frame synchronized with the frame generated by another base station apparatus 10.

When the processing unit 26 cannot receive the packet signal from another base station apparatus 10, this may execute a following process. The processing unit 26 receives the signal from the GPS satellite not illustrated and acquires information of time with reference to the received signal. Meanwhile, the well-known technology may be used to acquire the information of time, so that the description thereof is herein omitted. The processing unit 26 generates a plurality of frames based on the information of time. For example, the processing unit 26 generates 10 frames of “100 msec” by dividing a period of “1 sec” into ten parts based on timing of “0 msec”.

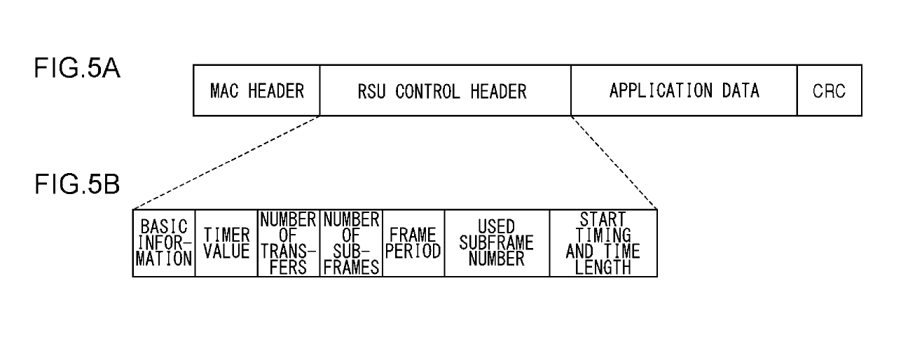

The processing unit 26 inputs the demodulated result from another base station apparatus 10 or the terminal apparatus not illustrated through the RF unit 22 and the modem unit 24. Herein, a configuration of a MAC frame stored in the packet signal is described as the demodulated result. Meanwhile, the configuration of the MAC frame input to the processing unit 26 and that of the MAC frame output from the processing unit 26 are similar to each other. FIGS. 5A and 5B illustrate a format of the MAC frame stored in the packet signal defined by the communication system 100. FIG. 5A illustrates the format of the MAC frame. In the MAC frame, a “MAC header”, a “RSU control header”, “application data”, and a “CRC” are arranged in this order from a head thereof. The RSU control header corresponds to the above-described control information. Data, which should be notified to the terminal apparatus, such as accident information, is stored in the application data.

FIG. 5B illustrates a format of the RSU control header. In the RSU control header, “basic information”, a “timer value”, a “number of transfers”, a “number of subframes”, a “frame period”, a “used subframe number”, and “start timing and time length” are arranged in this order from a head thereof. Meanwhile, a configuration of the RSU control header is not limited to that in FIG. 5B, a part of elements may be removed, and another element may be included. The number of transfers indicates the number of transfers of the control information transmitted from the base station apparatus 10, especially contents of the RSU control header by the terminal apparatus not illustrated. Herein, the base station apparatus 10 corresponds to this base station apparatus 10 for the MAC frame output from the processing unit 26, and the base station apparatus 10 corresponds to another base station apparatus 10 for the MAC frame input to the processing unit 26. This is common also in a following description.

The generating unit 36 to be described later sets the number of transfers to “0” for the MAC frame output from the processing unit 26. Also, the number of transfers is set to “1” or larger for the MAC frame input to the processing unit 26. The number of subframes indicates the number of subframes, which form one frame. The frame period indicates the period of the frame and is set to “100 msec”, for example, as described above. The used subframe number is the number of the subframe in which the base station apparatus 10 sets the inter-vehicle transmission period. As illustrated in FIG. 3A, the subframe number is set to “1” on the head of the frame. In the start timing and time length, the start timing of the road-to-vehicle transmission period, which is at the head of the subframe, and the time length of the road-to-vehicle transmission period are indicated. FIG. 2 is referred to again.

The processing unit 26 extracts the MAC frame in which the number of transfers is set to “0” out of the MAC frames. This corresponds to the packet signal directly transmitted from another base station apparatus 10. The processing unit 26 specifies a value of the used subframe number of the extracted MAC frame. This corresponds to specification of the subframe used by another base station apparatus 10. The processing unit 26 measures the received power of the packet signal received by the RF unit 22 in units of packet signal. Also, the processing unit 26 extracts the received power of the packet signal arranged on the head of the already specified subframe. This corresponds to extraction of the received power of the packet signal from another base station apparatus 10.

The processing unit 26 extracts the MAC frame in which the number of transfers is set to “1” or larger out of the MAC frames input to the processing unit 26. This corresponds to the packet signal transferred by the terminal apparatus after being transmitted from another base station apparatus 10. The processing unit 26 specifies the value of the used subframe number of the extracted MAC frame. This corresponds to the specification of the subframe used by another base station apparatus 10. Meanwhile, the terminal apparatus transfers the subframe number when the terminal apparatus receives the packet signal from another base station apparatus 10.

The processing unit 26 measures the received power of the packet signal. Also, the processing unit 26 estimates that the measured received signal is the received power of the packet signal from another base station apparatus 10 of which control information is transferred by this packet signal. The processing unit 26 specifies the subframe in which the road-to-vehicle transmission period should be set. Specifically, the processing unit 26 confirms whether an “unused” subframe is present. If this is present, the processing unit 26 selects any “unused” subframe. Herein, when there are a plurality of unused subframes, the processing unit 26 randomly selects one subframe. When there is no unused subframe, that is to say, when each of a plurality of subframes is used, the processing unit 26 preferentially specifies the subframe of which received power is low. The processing unit 26 outputs the specified subframe number to the generating unit 36.

The generating unit 36 accepts the specified subframe number from the processing unit 26. Also, the generating unit 36 sets the road-to-vehicle transmission period on the head part of the subframe of the accepted subframe number. The generating unit 36 generates the MAC frame, which should be stored in the packet signal. At that time, according to the setting of the road-to-vehicle transmission period, the generating unit 36 determines a value of the RSU control header of the MAC frame. The generating unit 36 acquires predetermined information through the network communicating unit 80 and includes the predetermined information in the application data. Herein, the network communicating unit 80 is connected to a network 202 not illustrated. The generating unit 36 allows the modem unit 24 and the RF unit 22 to transmit the packet signal during the road-to-vehicle transmission period. The control unit 30 controls a process of an entire base station apparatus 10.

This configuration may be realized by a CPU, a memory, and another LSI of an optional computer in a hardware aspect and is realized by a program loaded on the memory and the like in a software aspect; however, a functional block realized by combination of them is herein illustrated. Therefore, one skilled in the art may comprehend that the functional block may be realized in various modes only by hardware, only by software, and by combination of them.

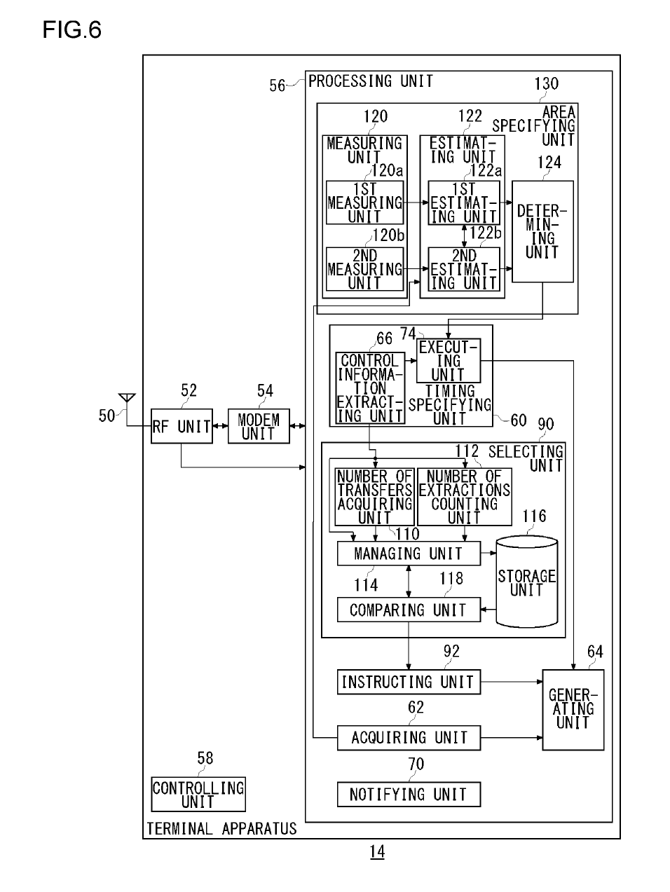

FIG. 6 illustrates a configuration of a terminal apparatus 14 mounted on the vehicle 12. That is to say, the terminal apparatus 14 might be moved. The terminal apparatus 14 includes an antenna 50, an RF unit 52, a modem unit 54, a processing unit 56, and a control unit 58. Also, the processing unit 56 includes an area specifying unit 130, a timing specifying unit 60, an acquiring unit 62, a generating unit 64, a notifying unit 70, a selecting unit 90, and an instructing unit 92. The area specifying unit 130 includes a first measuring unit 120a and a second measuring unit 120b collectively referred to as measuring units 120, a first estimating unit 122a and a second estimating unit 122b collectively referred to as estimating units 122, and a determining unit 124, the timing specifying unit 60 includes a control information extracting unit 66 and an executing unit 74, and the selecting unit 90 includes a number of transfers acquiring unit 110, a number of extractions counting unit 112, a managing unit 114, a storage unit 116, and a comparing unit 118. The antenna 50, the RF unit 52, and the modem unit 54 execute processes similar to those of the antenna 20, the RF unit 22, and the modem unit 24 in FIG. 2, respectively. Therefore, the description thereof is herein omitted.

The modem unit 54 and the processing unit 56 receive the packet signal from the base station apparatus 10. Meanwhile, as described above, the subframe in which the priority period and the general period are time-division multiplexed is defined. The priority period is the period, which should be used by the terminal apparatus 14 present in the first area 210 formed around the base station apparatus 10 for transmitting the packet signal. The general period is the period, which should be used by the terminal apparatus 14 present in the second area formed on the outside of the first area 210 for transmitting the packet signal. Also, the frame in which a plurality of subframes are time-division multiplexed is defined.

The first measuring unit 120a measures the received power of the received packet signal. The well-known technology may be used as a method of measuring the received power, so that the description thereof is herein omitted. Meanwhile, the first measuring unit 120a may also measure SNR, SIR and the like in place of the received power. The first measuring unit 120a outputs the measured received power to the first estimating unit 122a. The second measuring unit 120b measures the error rate of the received packet signal. As the error rate, a bit error rate (BER), a packet error rate (PER) and the like are measured, for example. The second measuring unit 120b outputs the measured error rate to the second estimating unit 122b. In this manner, the measuring unit 120 measures the quality of the received packet signal.

The first estimating unit 122a estimates whether the terminal apparatus is present in the first area 210 or in the second area 212 based on the received power measured by the first measuring unit 120a. The second estimating unit 122b estimates whether the terminal apparatus is present in the second area 212 or on the outside of the second area 214 based on the error rate measured by the second measuring unit 120b. As a result, the first estimating unit 122a and the second estimating unit 122b estimate in cooperation with each other in which of the first area 210, the second area 212, and the outside of the second area 214 the terminal apparatus is present. A specific process of estimation is to be described later. Meanwhile, an error number may be used in place of the error rate. The first estimating unit 122a and the second estimating unit 122b output the estimated result to the determining unit 124.

The determining unit 124 determines any of the priority period, the general period, timing unrelated to the configuration of the frame as the transmission period based on at least one of the estimated result by the second estimating unit 122b and the estimated result by the first estimating unit 122a. Specifically described, when the second estimating unit 122b estimates the presence on the outside of the second area 214, the determining unit 124 selects the timing unrelated to the configuration of the frame. When the first estimating unit 122a and the second estimating unit 122b estimate the presence in the second area 212, the determining unit 124 selects the general period. When the first RF unit 22a estimates the presence in the first area 210, the determining unit 124 selects the priority period. The modem unit 24 outputs a selected result to the executing unit 74.

Herein, the estimation process of the area by the first estimating unit 122a and the second estimating unit 122b is described. First, the estimation process between the outside of the second area 214 and the second area 212 is described. The second estimating unit 122b estimates entry from the outside of the second area 214 to the second area 212 when it transits from a state in which the error rate is higher than the threshold to a state in which the error rate is not higher than the threshold. Herein, the state in which the error rate is higher than the threshold corresponds to the presence on the outside of the second area 214 and the state in which the error rate is not higher than the threshold corresponds to the presence in the second area 212. When the terminal apparatus is present on the outside of the second area 214, the first estimating unit 122a stops estimating. On the other hand, when the second estimating unit 122b estimates the entry to the second area 212, the first estimating unit 122a starts estimating.

In a case in which the first and second estimating units 122a and 122b estimate the presence in the second area, the second estimating unit 122b estimates escape from the second area 212 to the outside of the second area 214 when it transits from the state in which the error rate is not higher than the threshold to the state in which the error rate is higher than the threshold. Herein, the case in which the second estimating unit 122b estimates the presence in the second area 212 is the above-described state and the case in which the first estimating unit 122a estimates the presence in the second area 212 is to be described later. When the second estimating unit 122b estimates the escape to the outside of the second area 214, the first estimating unit 122a stops estimating.

Herein, the second estimating unit 122b does not immediately estimate the entry to the second area 212 even when it transits from the state in which the error rate is higher than the threshold to the state in which the error rate is not higher than the threshold. When it is in the state in which the error rate is not higher than the threshold in a plurality of consecutive frames, the second estimating unit 122b estimates the entry to the second area 212. For example, the number of required frames is set to “3”. Herein, a condition for movement to the area closer to the base station apparatus 10 is referred to as a “first condition” and the first condition for the movement from the outside of the second area 214 to the second area 212 is that “the error rate is not higher than the threshold in three consecutive frames from the state in which the error rate is higher than the threshold”.

On the contrary, the condition for the movement to the area away from the base station apparatus 10 is referred to as a “second condition”. For example, the second condition for the movement from the second area 212 to the outside of the second area 214 is that “the error rate is higher than the threshold in five consecutive frames from the state in which the error rate is not higher than the threshold”. In this manner, the second estimating unit 122b estimates the entry from the outside of the second area 214 to the second area 212 when the measured error rate is improved so as to satisfy the first condition and estimates the entry from the second area 212 to the outside of the second area 214 when the measured error rate is deteriorated so as to satisfy the second condition.

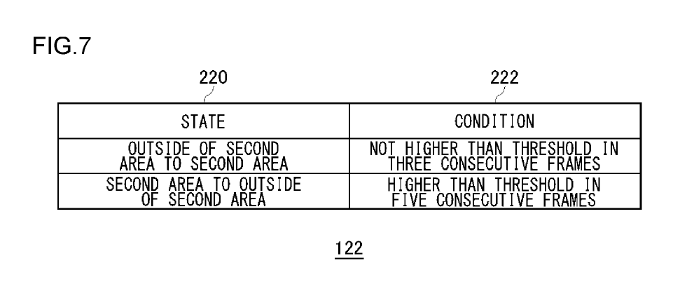

Also, the number of frames included in the first condition and the number of frames included in the second condition are set such that the entry from the second area 212 to the outside of the second area 214 is more difficult than the entry from the outside of the second area 214 to the second area 212. That is to say, the hysteresis is provided. This is for increasing possibility that the terminal apparatus is estimated to be present in the second area 212 than the possibility that this is estimated to be present on the outside of the second area 214 in the vicinity of an end of the second area 212. FIG. 7 illustrates a data structure of a table stored in the estimating unit 122. A state field 220 and a condition field 222 are included. An upper row corresponds to the first condition and a lower row corresponds to the second condition. FIG. 6 is referred to again.

Next, the estimation process between the second area 212 and the first area 210 is described. When the first and second estimating units 122a and 122b estimate the presence in the second area 212, the first estimating unit 122a estimates the entry from the second area 212 to the first area 210 when it transits from a state in which the received power is lower than the threshold to a state in which the received power is not lower than the threshold. Herein, the state in which the received power is lower than the threshold corresponds to the presence in the second area 212 and the state in which the received power is not lower than the threshold corresponds to the presence in the first area 210. When the first estimating unit 122a estimates the entry to the first area 210, the second estimating unit 122b stops estimating.

The first estimating unit 122a estimates the entry from the first area 210 to the second area 212 when it transits from the state in which the received power is not lower than the threshold to the state in which the received power is lower than the threshold. The second estimating unit 122b stops estimating when the terminal apparatus is present in the first area 210. The second estimating unit 122b starts estimating when the first estimating unit 122a estimates the entry to the second area 212.

As the second estimating unit 122b, the first estimating unit 122a also sets the first and second conditions for the movement between the first and second areas 210 and 212. The second estimating unit 122b sets different values for the number of frames included in the first condition and the number of frames included in the second condition as the first estimating unit 122a. Further, the second estimating unit 122b acquires a moving speed of the vehicle 12 on which the terminal apparatus 14 is mounted through the acquiring unit 62. The different values are set for the numbers of frames included in the first and second conditions according to the moving speed. Specifically, the first condition for the movement from the second area 212 to the first area 210 is that “the received power is not lower than the threshold in 10 consecutive frames from the state in which the received power is lower than the threshold” in a case of 0 km/h to 30 km/h. Also, the number of frames in the first condition is set to “8”, “6”, and “4” for each case of 30 km/h to 60 km/h, 60 km/h to 80 km/h, and 80 km/h or higher, respectively.

The second condition for the movement from the first area 210 to the second area 212 is set in the same manner as the first condition and this is that, for example, “the received power is lower than the threshold in eight consecutive frames from the state in which the received power is not lower than the threshold” in a case of 0 km/h to 30 km/h. Also, the number of frames in the second condition is set to “6”, “4”, and “2” for each case of 30 km/h to 60 km/h, 60 km/h to 80 km/h, and 80 km/h or higher, respectively. In this manner, the first estimating unit 122a estimates the entry from the second area 212 to the first area 210 when the measured received power is improved so as to satisfy the first condition and estimates the entry from the first area 210 to the second area 212 when the measured received power is deteriorated so as to satisfy the second condition.

Also, the number of frames included in the second condition and the number of frames included in the second condition are set such that the entry from the second area 212 to the first area 210 is more difficult than the entry from the first area 210 to the second area 212. That is to say, the hysteresis is provided. This is for increasing the possibility that the terminal apparatus is estimated to be present in the second area 212 than the possibility that this is estimated to be present in the first area 210 in the vicinity of an end of the first area 210. As described above, the terminal apparatus 14 present in the first area 210 uses the priority period. The priority period is formed of a plurality of slots, so that the number of the terminal apparatuses 14, which may use the priority period, is limited to the number of slots. On the other hand, the terminal apparatus 14 present in the second area 212 uses the general period. Since the general period is not formed of a plurality of slots, flexibility of the number of terminal apparatuses 14 is higher than that in the priority period. Therefore, the above-described hysteresis is set so as to increase the number of terminal apparatuses 14, which are allowed to execute transmission according to the configuration of the frame.

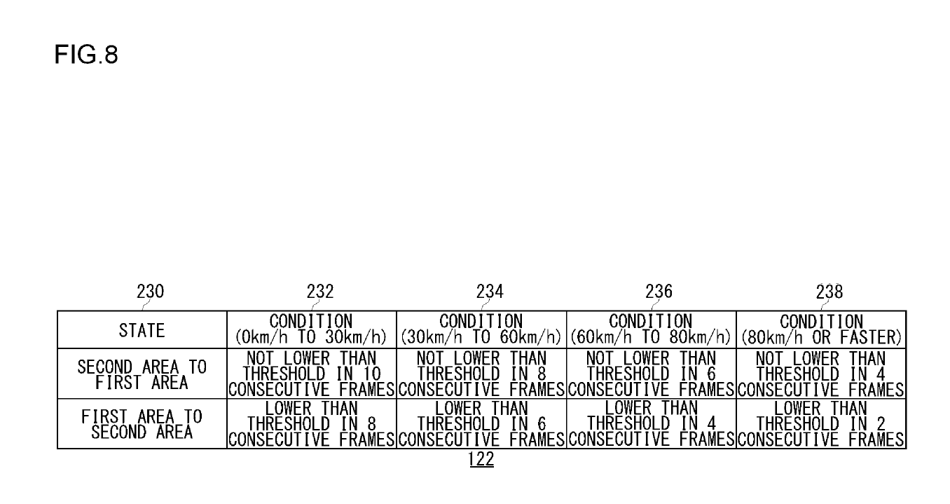

Further, the first estimating unit 122a sets the number of frames included in the first condition and the number of frames included in the second condition such that the entry from the first area 210 to the vehicle 12 and the entry from the second area 212 to the first area 210 become difficult as the moving speed becomes lower. At the time of travel in the vicinity of the boundary between the first area 210 and the second area 212, the first area 210 and the second area 212 might be selected in a switching manner by variation in the received power. Also, it is switched at a higher level as the moving speed is lower. In consideration of the stability of the communication system 100, it is preferable that it is not switched frequently. According to this, the above-described hysteresis is set. FIG. 8 illustrates the data structure of another table stored in the estimating unit 122. A state field 230, a condition (0 km/h to 30 km/h) field 232, a condition (30 km/h to 60 km/h) field 234, a condition (60 km/h to 80 km/h) field 236, and a condition (80 km/h or higher) field 238 are included. An upper row corresponds to the first condition and a lower row corresponds to the second condition. FIG. 6 is referred to again.

The acquiring unit 62 includes the GPS receiver, a gyroscope, a vehicle speed sensor and the like not illustrated, and acquires the position of presence, a traveling direction, the moving speed and the like of the vehicle 12 not illustrated, that is to say, the vehicle 12 on which the terminal apparatus 14 is mounted by the data supplied from them. Meanwhile, the position of presence is represented by latitude and longitude. The well-known technology may be used for acquiring them, so that the description thereof is herein omitted. The acquiring unit 62 outputs the acquired information to the generating unit 64.

The control information extracting unit 66 accepts the packet signal from the RF unit 52 or the demodulated result from the modem unit 54. Also, the control information extracting unit 66 specifies the timing of the subframe in which the road-to-vehicle transmission period is arranged when the demodulated result is the packet signal from the base station apparatus 10 not illustrated. Also, the control information extracting unit 66 generates the frame based on the timing of the subframe and the contents of the RSU control header. Meanwhile, the frame may be generated in the same manner as in the above-described processing unit 26, so that the description thereof is herein omitted. As a result, the control information extracting unit 66 generates the frame synchronized with the frame formed by the base station apparatus 10. Also, the control information extracting unit 66 specifies the road-to-vehicle transmission period based on the contents of the RSU control header.

Further, the control information extracting unit 66 selects any of a plurality of subframes and specifies the period other than the road-to-vehicle transmission period of the selected subframe as the inter-vehicle transmission period. Specifically, a part of the inter-vehicle transmission period is specified as the priority period and the rest of the inter-vehicle transmission period is specified as the general period. For example, a length of the priority period is determined in advance and a length of the general period is derived by subtracting the priority period from the inter-vehicle transmission period. The control information extracting unit 66 outputs information about the timings of the frame and the subframe and the inter-vehicle transmission period to the executing unit 74.

The executing unit 74 accepts information about the transmission period from the determining unit 124. The executing unit 74 selects any of the priority period, the general period, and the timing unrelated to the configuration of the frame based on the information about the transmission period. Also, the executing unit 74 inputs the information about the timings of the frame and the subframe and the inter-vehicle transmission period from the control information extracting unit 66. Based on them, the executing unit 74 recognizes the timings of the frame and the subframe, the priority period, and the general period. When selecting the priority period, the executing unit 74 selects any of the slots included in the priority period. For example, the slot having the lowest received power is selected. The executing unit 74 determines the selected slot as transmission timing.

When selecting the general period, the executing unit 74 executes the CSMA in the general period. Specifically described, the executing unit 74 measures interference power by executing carrier sense. Also, the executing unit 74 determines the transmission timing based on the interference power. Specifically described, the executing unit 74 stores a predetermined threshold in advance and compares the interference power with the threshold. When the interference power is lower than the threshold, the executing unit 74 determines the transmission timing. When selecting the timing unrelated to the configuration of the frame, the executing unit 74 determines the transmission timing by executing the CSMA without considering the configuration of the frame. The executing unit 74 notifies the generating unit 64 of the determined transmission timing.

The generating unit 64 generates the data so as to include the information acquired by the acquiring unit 62. At that time, the MAC frame illustrated in FIGS. 5A and 5B is used and the generating unit 64 stores the measured position of presence in the application data. The generating unit 64 broadcast-transmits the packet signal including the data through the modem unit 54, the RF unit 52, and the antenna 50 at the transmission timing determined by the executing unit 74. The notifying unit 70 acquires the packet signal from the base station apparatus 10 not illustrated during the road-to-vehicle transmission period and acquires the packet signal from another terminal apparatus 14 not illustrated during the inter-vehicle transmission period. The notifying unit 70 notifies a driver of the approach and the like of another vehicle 12 not illustrated by means of a monitor and a speaker according to the contents of the data stored in the packet signal.

Hereinafter, transfer of the RSU control header by the terminal apparatus 14 is described. The control information extracting unit 66 extracts the RSU control header from the packet signal of which information source is the base station apparatus 10. As described above, although the number of transfers is set to “0” when the packet signal is directly transmitted from the base station apparatus 10, the number of transfers is set to a value “not smaller than 1” when the packet signal is transmitted from another terminal apparatus 14. Herein, the used subframe number is not changed when being transferred by the terminal apparatus 14, so that the subframe used by the base station apparatus 10, which is the information source, is specified with reference to the used subframe number.

The number of transfers acquiring unit 110 acquires information about the number of transfers for each base station apparatus 10, which is the information source. Specifically described, the number of transfers acquiring unit 110 sequentially acquires the number of transfers corresponding to the subframe number “1” and thereafter executes the similar process also for the number of transfers corresponding to another subframe number. Further, for each base station apparatus 10, which is the information source, the number of transfers acquiring unit 110 acquires a smaller number of transfers, for example, a minimum value of the number of transfers out of the information about the number of transfers related to this base station apparatus 10. That is to say, the number of transfers acquiring unit 110 acquires the minimum value of the number of transfers corresponding to the subframe number “1”, the minimum value of the number of transfers corresponding to the subframe number “2” and the like.

The number of extractions counting unit 112 counts the number of extractions of the RSU control headers, that is to say, the control information for each base station apparatus 10, which is the information source. Also, the number of extractions counting unit 112 selects the number of extractions of the control information including the value of the number of transfers acquired by the number of transfers acquiring unit 110 for each base station apparatus 10, which is the information source. Specifically described, the number of extractions counting unit 112 counts the number of extractions of the control information for each number of transfers for one subframe number. As a result, for example, for the subframe number “1”, the number of extractions of the control information of which number of transfers is “0” is “0”, the number of extractions of the control information of which number of transfers is “1” is “4”, and the number of extractions of the control information of which number of transfers is “2” is “6”. Also, when the number of transfers acquired by the number of transfers acquiring unit 110 is “1”, the number of extractions counting unit 112 selects the number of extractions “4” of the control information including this number of transfers. The number of extractions counting unit 112 outputs the selected number of extractions to the managing unit 114 for each base station apparatus 10, which is the information source.

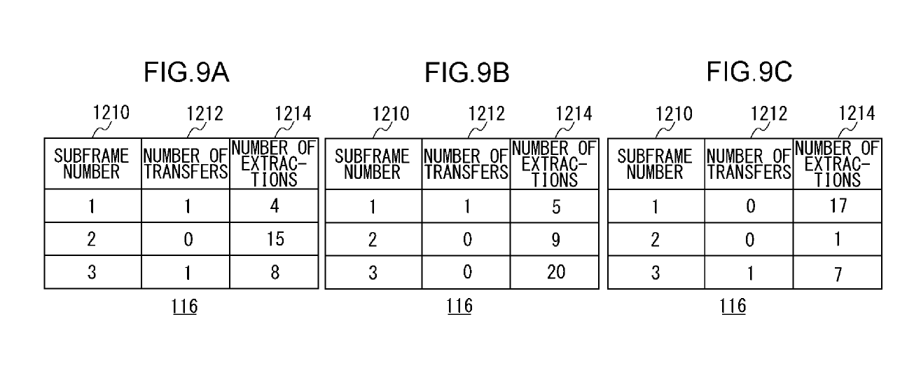

The managing unit 114 accepts the number of transfers from the number of transfers acquiring unit 110 and the number of extractions from the number of extractions counting unit 112. The managing unit 114 associates the subframe number, the number of transfers, and the number of extractions with each other and stores them in the storage unit 116. Also, the managing unit 114 updates stored contents in the storage unit 116 when the number of transfers and the number of extractions are updated. The storage unit 116 associates the subframe number, the number of transfers, and the number of extractions with each other to store according to an instruction from the managing unit 114. FIGS. 9A to 9C illustrate the data structures of the table stored in the storage unit 116. They correspond to the data structure of the table stored in the storage unit 116 in another terminal apparatus 14 and are stored in the storage unit 116 of the terminal apparatus 14 mounted on each of the first to third vehicles 12a to 12c, for example.

Each table includes a subframe number field 1210, a number of transfers field 1212 and a number of extractions field 1214. The value indicated in the used subframe number in FIG. 5B is input to the subframe number field 1210. The number of transfers acquired by the number of transfers acquiring unit 110 is input to the number of transfers field 1212, and the number of extractions acquired by the number of extractions counting unit 112 is input to the number of extractions field 1214. In FIG. 9A, the control information of which information source is the base station apparatus 10 corresponding to the subframe number “1” having the number of transfers “1” as the minimum number of transfers is extracted “four” times. On the other hand, in FIG. 9A, the control information of which information source is the base station apparatus 10 corresponding to the subframe number “2” having the number of transfers “0” as the minimum number of transfers is extracted “15” times. FIG. 6 is referred to again.

The comparing unit 118 acquires the number of transfers and the number of extractions for each base station apparatus 10 by accessing the storage unit 116. The comparing unit 118 selects the control information corresponding to at least one base station apparatus 10 as the control information, which should be transferred, based on the number of transfers and the number of extractions. Specifically described, the comparing unit 118 compares the numbers of extractions after comparing the numbers of transfers for a plurality of base station apparatuses 10. That is to say, after the control information of which number of transfers is smaller, for example, the control information having the minimum number of transfers is selected, the control information of which number of extractions is larger, the control information having a maximum number of extractions is selected out of the selected control information. In a case of FIG. 9B, the minimum number of transfers is “0” corresponding to the subframe numbers “2” and “3”, so that the comparing unit 118 selects the control information of the subframe numbers “2” and “3” as a first stage. Subsequently, since the number of extractions of the subframe number “2” is “9” and the number of extractions of the subframe number “3” is “20”, the latter number of extractions is larger, so that the comparing unit 118 selects the control information of the subframe number “3” as a second stage.

In this manner, the control information having the minimum number of transfers and the control information having the maximum number of extractions corresponding to this number of transfers is selected by the comparing unit 118. It may be said that the control information is received on a position closer to the base station apparatus 10, which is the information source, as the number of transfers is smaller. Also, it may be said that the control information is received in a status in which variation in a wireless environment is smaller as the number of extractions is larger. Therefore, it may be said that, by selecting the control information, which satisfies the above-described status, the terminal apparatus 14 selects the control information from the base station apparatus 10 provided as close as possible.

The instructing unit 92 instructs the generating unit 36 to generate the RSU control header based on the control information selected by the comparing unit 118. When storing the control information in the RSU control header, the instructing unit 92 increases the number of transfers in the information about the number of transfers. According to such instruction, the generating unit 64 generates the RSU control header based on the control information selected by the comparing unit 118 and increases the number of transfers at that time. Meanwhile, the instructing unit 92 notifies the managing unit 114 that the number of transfers is increased and the managing unit 114 controls the storage unit 116 so as to increase the number of transfers of the corresponding control information. The control unit 58 controls operation of an entire terminal apparatus 14.

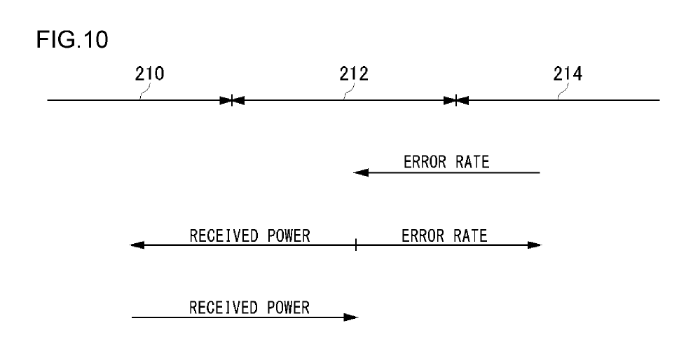

Operation of the communication system 100 by the above-described configuration is described. FIG. 10 illustrates an outline of the estimation process by the estimating unit 122. The first area 210, the second area 212, and the outside of the second area 214 are indicated in an uppermost row from left in this order. A next row indicates that the movement from the outside of the second area 214 to the second area 212 is estimated based on the error rate. A next row indicates that the movement from the second area 212 to the outside of the second area 214 is estimated based on the error rate and the movement from the second area 212 to the first area 210 is estimated based on the received power. That is to say, when the terminal apparatus is present in the second area 212, both of the error rate and the received power are monitored. A next row indicates that the movement from the first area 210 to the second area 212 is estimated based on the received power.

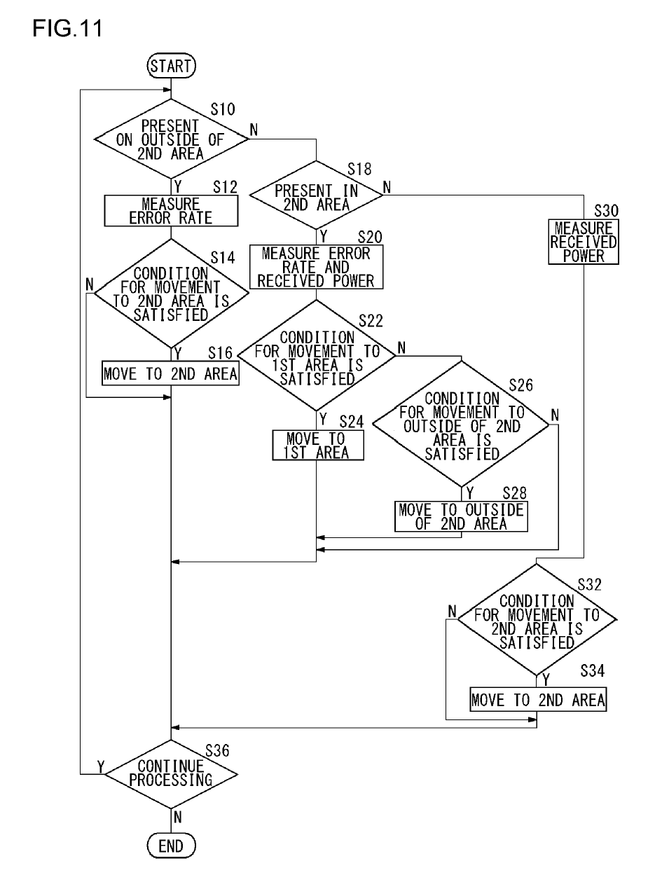

FIG. 11 is a flowchart illustrating an estimation procedure of the area by the terminal apparatus 14. When this is present on the outside of the second area 214 (Y at S10), the second measuring unit 120b measures the error rate (S12). When the condition for the movement to the second area 212 is satisfied (Y at S14), the second estimating unit 122b estimates the movement to the second area 212 (S16). When the condition for the movement to the second area 212 is not satisfied (N at S14), the step S16 is skipped. When the terminal apparatus is not present on the outside of the second area 214 (N at S10) and this is present in the second area 212 (Y at S18), the second measuring unit 120b measures the error rate and the first measuring unit 120a measures the received power (S20). When the condition for the movement to the first area 210 is satisfied (Y at S22), the first estimating unit 122a estimates the movement to the first area 210 (S24).

When the condition for the movement to the first area 210 is not satisfied (N at S22) and the condition for the movement to the outside of the second area 214 is satisfied (Y at S26), the second estimating unit 122b estimates the movement to the outside of the second area 214 (S28). When the condition for the movement to the outside of the second area 214 is not satisfied (N at S26), the step 28 is skipped. When the terminal apparatus is not present in the second area 212 (N at S18), the first measuring unit 120a measures the received power (S30). When the condition for the movement to the second area 212 is satisfied (Y at S32), the first estimating unit 122a estimates the movement to the second area 212 (S34). When the condition for the movement to the second area 212 is not satisfied (N at S32), the step 34 is skipped. When the process is continued (Y at S36), the procedure returns to the step 10. When the process is not continued (N at S36), the process is finished.

Next, a modified example is described. The modified example relates to the communication system similar to that in the embodiment. In the embodiment, the first and second areas are formed around the base station apparatus. On the other hand, in the modified example, only one type of area is formed around the base station apparatus. Herein, suppose that the one type of area is the second area. Meanwhile, the one type of area may be the first area. When the terminal apparatus according to the modified example accepts information about absence of the first area (hereinafter, referred to as “area information”), this stops the estimation process based on the received power by the first estimating unit. As a result, the terminal apparatus estimates only the movement between the second area and the outside of the second area based on the error rate. The communication system 100 according to the modified example is of the same type as that in FIG. 1, the base station apparatus 10 is of the same type as that in FIG. 2, and the terminal apparatus 14 is of the same type as that in FIG. 6.

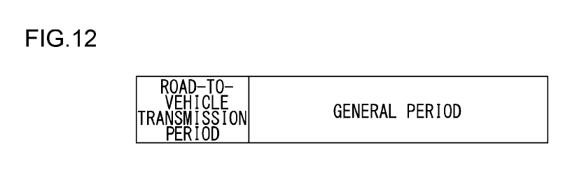

The base station apparatus 10 in FIG. 2 forms only the second area 212 without forming the first area 210 in the communication system 100 in FIG. 1. Also, the base station apparatus 10 defines the subframe illustrated in FIG. 12 in place of the subframe illustrated in FIG. 4. FIG. 12 illustrates the configuration of the subframe according to the modified example of the present invention. As illustrated, one subframe is composed of the road-to-vehicle transmission period and the general period in this order and this does not include the priority period. Although the MAC frame according to the modified example is composed as in FIG. 5A, the area information is also included in the RSU control header in addition to the configuration illustrated in FIG. 5B.

On the other hand, the control information extracting unit 66 of the terminal apparatus 14 illustrated in FIG. 6 extracts the area information included in the RSU control header. When the area information indicates that the first area 210 is not formed, the control information extracting unit 66 outputs the fact to the area specifying unit 130. This corresponds to acceptance of information about the fact that only the second area 212 is formed around the base station apparatus 10 by the control information extracting unit 66. The first estimating unit 122a stops estimating when this is notified of the absence of the first area 210. This corresponds to execution of only the estimation process based on the error rate by the second estimating unit 122b.

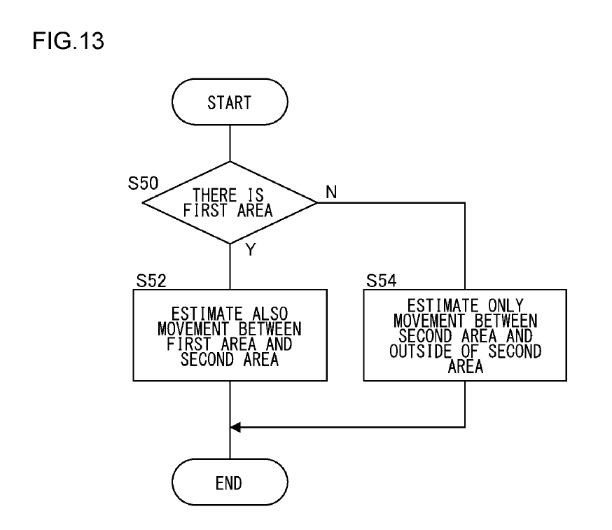

FIG. 13 is a flowchart illustrating the estimation procedure of the area according to the modified example of the present invention. When there is the first area 210 around the base station apparatus 10 (Y at S50), the area specifying unit 130 also estimates the movement between the first area 210 and the second area 212 (S52). That is to say, the process according to the flowchart illustrated in FIG. 11 is executed. On the other hand, when there is no first area 210 around the base station apparatus 10 (N at S50), the area specifying unit 130 estimates only the movement between the second area 212 and the outside of the second area 214 (S54). That is to say, out of the flowchart illustrated in FIG. 11, the process by the first estimating unit 122a is not performed.

Meanwhile, it is possible that only the second area 212 is formed around the base station apparatus 10 and the first area 210 is not at all formed. In this case, it is possible that the area information is not included in the RSU control header. Further, it is possible that the first estimating unit 122a is not included in the terminal apparatus 14.

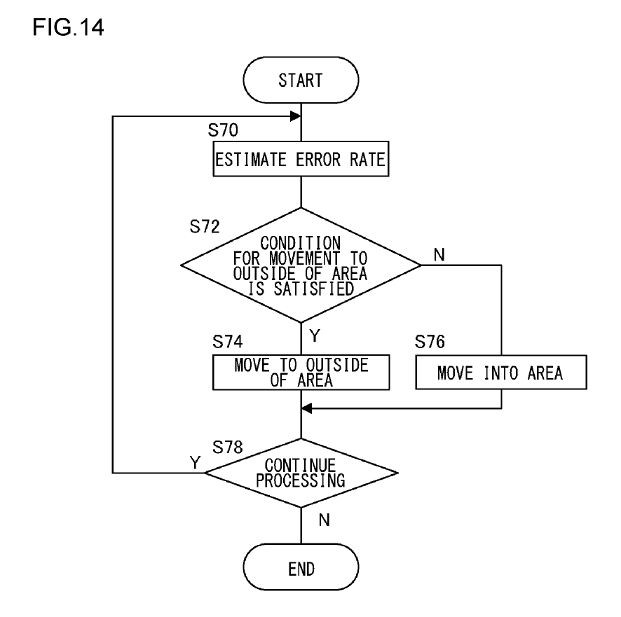

FIG. 14 is a flowchart illustrating another estimation procedure of the area according to the modified example of the present invention. The second measuring unit 120b measures the error rate (S70). When the condition for the movement to the outside of the second area 214 is satisfied (Y at S72), the second estimating unit 122b estimates the movement to the outside of the second area 214 (S74). When the condition for the movement to the outside of the second area 214 is not satisfied (N at S72), the second estimating unit 122b estimates the movement into the second area 212 (S76). When the process is continued (Y at S78), the procedure returns to the step 70. When the process is not continued (N at S78), the process is finished.

According to the embodiment of the present invention, since the error rate is used for distinguishing the second area and the outside of the second area, the end of the second area may be defined based on whether the packet signal from the base station apparatus may be received. Also, since the end of the second area is defined based on whether the packet signal from the base station apparatus may be received, it is possible to widen the second area. Also, since the received power is used for distinguishing the first area from the second area, a range in which propagation loss is within a predetermined level may be defined as the first area. Since the range in which the propagation loss is within the predetermined level is defined as the first area, the vicinity of the center of the intersection may be used as the first area.

Also, since the received power is not used for distinguishing the second area from the outside of the second area and the error rate is not used for distinguishing the first area from the second area, it is possible to inhibit erroneous judgment. Also, since the priority period is used when the terminal apparatus is present in the first area and the general period is used when this is present in the second area, it is possible to decrease the collision probability of the packet signal from the terminal apparatus present in the first area with the packet signal from the terminal apparatus present in the second area. Also, since the time-division multiplex by the slots is executed in the priority period, it is possible to decrease the error rate. Also, since the CSMA/CA is executed in the general period, the number of terminal apparatuses may be flexibly adjusted.

Also, since the hysteresis is provided for the error rate when distinguishing the second area from the outside of the second area, it is possible to decrease occurrence of the status in which the both states are frequently switched. Also, since the occurrence of the status in which the both states are frequently switched is decreased, it is possible to improve the stability of the communication system. Also, since the hysteresis is provided such that the terminal apparatus is easily estimated to be present in the second area, it is possible to increase the number of terminal apparatuses, which execute the communication according to the frame configuration. Also, since the hysteresis is provided for the received power when distinguishing the first area from the second area, it is possible to decrease the occurrence of the status in which the both states are frequently switched.

Also, since the hysteresis is provided such that the terminal apparatus is easily estimated to be present in the second area than in the first area, it is possible to decrease the number of terminal apparatuses, which should use the priority period. Also, since the number of terminal apparatuses, which should use the priority period, is decreased, it is possible to decrease the collision probability of the packet signals during the priority period. Also, since the collision probability of the packet signals in the priority period is decreased, it is possible to preferentially transmit the packet signal from the terminal apparatus in the vicinity of the center of the intersection.

Also, since the subframe used by another base station apparatus is specified based on not only the packet signal directly received from another base station apparatus but also the packet signal received from the terminal apparatus, it is possible to improve specifying accuracy of the subframe in use. Also, since the specifying accuracy of the subframe in use is improved, it is possible to decrease the collision probability of the packet signals transmitted from the base station apparatuses. Also, since the collision probability of the packet signals transmitted from the base station apparatuses is decreased, it is possible that the terminal apparatus correctly recognizes the control information. Also, since the control information is correctly recognized, it is possible that the road-to-vehicle transmission period is correctly recognized. Also, since the road-to-vehicle transmission period is correctly recognized, it is possible to decrease the collision probability of the packet signals.

Also, since other than the subframe in use is preferentially used, it is possible to decrease the possibility of transmitting the packet signal at timing overlapped with that of the packet signal from another base station apparatus. Also, since the subframe of which received power is low is selected when all the subframes are used by the other base station apparatuses, it is possible to inhibit an effect of interference of the packet signal. Also, as the received power from another base station apparatus, which is a source of the control information relayed by the terminal apparatus, since the received power of this terminal apparatus is used, so that it is possible to make the estimation process of the received power easy. Also, when only one type of area is formed, this fact is notified, so that an unnecessary process out of the estimation process by the terminal apparatus may be omitted. Also, since the unnecessary process is omitted, it is possible to decrease the throughput of the estimation process by the terminal apparatus.

The present invention is described above based on the embodiment. The embodiment is illustrative only and one skilled in the art may comprehend that various modified examples of combination of each component and each process are possible and that the modified examples are within the scope of the present invention.

Although the first estimating unit 122a changes the first and second conditions according to the moving speed in the embodiment of the present invention, the second estimating unit 122b uses fixed first and second conditions. However, this is not limitation and the second estimating unit 122b may also change the first and second conditions according to the moving speed, for example. According to the modified example, it is possible to reflect the moving speed in judgment of switching between the first area 210 and the second area 212.

What is claimed is:

1. A terminal apparatus which might be moved, wherein a subframe in which a first period, which should be used by the terminal apparatus present in a first area formed around a base station apparatus for transmitting a packet signal, and a second period, which should be used by the terminal apparatus present in a second area formed on the outside of the first area for transmitting the packet signal, are time-division multiplexed is defined and a frame in which a plurality of subframes are time-division multiplexed is defined, the terminal apparatus comprising:
a receiving unit configured to receive the packet signal from the base station apparatus;
a measuring unit configured to measure a quality of the packet signal received by the receiving unit;
an estimating unit configured to estimate entry from the second area to the first area when the quality measured by the measuring unit is improved so as to satisfy a first condition and to estimate the entry from the first area to the second area when the quality measured by the measuring unit is deteriorated so as to satisfy a second condition;
a determining unit configured to determine the first period or the second period as transmission timing based on an estimated result by the estimating unit; and
a transmitting unit configured to transmit the packet signal at the transmission timing determined by the determining unit,
wherein
the estimating unit sets different values for a parameter included in the first condition and the parameter included in the second condition.

2. The terminal apparatus according to claim 1, wherein
the estimating unit sets the parameter included in the first condition and the parameter included in the second condition such that the entry from the second area to the first area is more difficult than the entry from the first area to the second area.

3. The terminal apparatus according to claim 1, further comprising an acquiring unit configured to acquire a moving speed of the terminal apparatus, wherein
the estimating unit sets the different values for the parameter included in the first condition and the parameter included in the second condition according to the moving speed.

4. The terminal apparatus according to claim 3, wherein
the estimating unit sets the parameter included in the first condition and the parameter included in the second condition such that the entry from the first area to the second area and the entry from the second area to the first area become more difficult as the moving speed becomes slower.

5. A terminal apparatus, which might be moved, wherein a subframe including a period, which should be used by the terminal apparatus present in an area formed around a base station apparatus for transmitting a packet signal is defined and a frame in which a plurality of subframes are time-division multiplexed is defined, the terminal apparatus comprising:
a receiving unit configured to receive the packet signal from the base station apparatus;
a measuring unit configured to measure a quality of the packet signal received by the receiving unit;
an estimating unit configured to estimate entry from the outside of the area to the area when the quality measured by the measuring unit is improved so as to satisfy a first condition and to estimate the entry from the area to the outside of the area when the quality measured by the measuring unit is deteriorated so as to satisfy a second condition;
a determining unit configured to determine the period or timing unrelated to a configuration of the frame as transmission timing based on an estimated result by the estimating unit; and
a transmitting unit configured to transmit the packet signal at the transmission timing determined by the determining unit,
wherein
the estimating unit sets different values for a parameter included in the first condition and the parameter included in the second condition.

6. A terminal apparatus, which might be moved, wherein a subframe in which a first period, which should be used by the terminal apparatus present in a first area formed around a base station apparatus for transmitting a packet signal, and a second period, which should be used by the terminal apparatus present in a second area formed on the outside of the first area for transmitting the packet signal, are time-division multiplexed is defined and a frame in which a plurality of subframes are time-division multiplexed is defined, the terminal apparatus comprising:
a receiving unit configured to receive the packet signal from the base station apparatus;
a first measuring unit configured to measure power of the packet signal received by the receiving unit;
a first estimating unit configured to estimate whether the terminal apparatus is present in the first area or in the second area based on the power measured by the first measuring unit;
a second measuring unit configured to measure an error rate of the packet signal received by the receiving unit;
a second estimating unit configured to estimate whether the terminal apparatus is present in the second area or on the outside of the second area based on the error rate measured by the second measuring unit;
a determining unit configured to determine any one of the first period, the second period, and timing unrelated to a configuration of the frame as transmission timing based on at least one of an estimated result by the second estimating unit and the estimated result by the first estimating unit; and
a transmitting unit configured to transmit the packet signal at the transmission timing determined by the determining unit,
wherein
the first estimating unit stops estimating when the terminal apparatus is present on the outside of the second area, and the second estimating unit stops estimating when the terminal apparatus is present in the first area.

7. The terminal apparatus according to claim 6, wherein
the second estimating unit estimates entry from the outside of the second area to the second area when it transits from a state in which an error rate is higher than a threshold to a state in which the error rate is not higher than the threshold, and
the first estimating unit starts estimating when the second estimating unit estimates the entry to the second area.

8. The terminal apparatus according to claim 6, wherein
when the first estimating unit and the second estimating unit estimate presence in the second area, the first estimating unit estimates entry from the second area to the first area when it transits from a state in which the power is lower than a threshold to a state in which the power is not lower than the threshold, and
the second estimating unit stops estimating when the first estimating unit estimates the entry to the first area.

9. The terminal apparatus according to claim 6, wherein
when the first estimating unit and the second estimating unit estimate presence in the second area, the second estimating unit estimates escape from the second area to the outside of the second area when it transits from a state in which the error rate is not higher than a threshold to a state in which the error rate is higher than the threshold, and
the first estimating unit stops estimating when the second estimating unit estimates the escape to the outside of the second area.

10. The terminal apparatus according to claim 6, wherein
the first estimating unit estimates entry from the first area to the second area when it transits from a state in which the power is not lower than a threshold to a state in which the power is lower than the threshold, and
the second estimating unit starts estimating when the first estimating unit estimates the entry to the second area.

11. The terminal apparatus according to claim 6, further comprising an accepting unit configured to accept information about a fact that only the second area is formed around the base station apparatus, wherein
the first estimating unit stops estimating when the accepting unit accepts the information about the fact that only the second area is formed around the base station apparatus.
